(19) United States
(12) Patent Application Publication
(10) Pub. No.: US 2023/0324517 A1
(43) Pub. Date: Oct. 12, 2023

(54) IRRADIATION DEVICE AND DISTANCE MEASUREMENT APPARATUS

(71) Applicant: FUJIFILM Business Innovation Corp., Tokyo (JP)

(72) Inventors: Hiroyuki HOTTA, Kanagawa (JP); Junichiro HAYAKAWA, Kanagawa (JP); Tomoaki SAKITA, Kanagawa (JP)

(73) Assignee: FUJIFILM Business Innovation Corp., Tokyo (JP)

(21) Appl. No.: 17/882,609

(22) Filed: Aug. 8, 2022

(30) Foreign Application Priority Data
Mar. 22, 2022 (JP) 2022-046006

(51) Int. Cl. G01S 7/481

(52) U.S. Cl. CPC G01S 7/4815

(57) ABSTRACT

An irradiation device includes a light source that performs irradiation with light, a refraction portion that has a curved region and is arranged at a position at which the curved region is directly irradiated with the light from the light source, and refracts the light of the irradiation from the light source, and a light reception portion that is arranged at a position, which is adjacent to the light source and at which reflective light reflected by the curved region after the irradiation from the light source is received, and that receives the reflective light.

### CROSS-REFERENCE TO RELATED APPLICATIONS

This application is based on and claims priority under 35 USC 119 from Japanese Patent Application No. 2022-046006 filed Mar. 22, 2022.

### BACKGROUND

### (I) Technical Field

The present invention relates to an irradiation device and a distance measurement apparatus.

### (II) Related Art

JP2016-130669A suggests a light source module including a surface emitting laser array that includes a plurality of light emission portions, a light separation element that is arranged on an optical path of light from the surface emitting laser array and separates the light into light for irradiation and light for light quantity monitoring, and a light reception element that is arranged on an optical path of the light for light quantity monitoring.

WO2010/100898A suggests a laser light source apparatus including a laser light source that emits laser light, a laser driving portion that drives the laser light source, a condensing lens that condenses the laser light and reflects a part of the laser light, an optical sensor that receives reflective laser light reflected by the condensing lens and outputs a detection signal corresponding to an intensity of the reflective laser light, and a control portion that controls the driving of the laser light source by the laser driving portion based on the detection signal, in which the condensing lens is arranged to be rotationally eccentric such that an optical axis of the condensing lens is inclined with respect to a center ray of the laser light incident on the condensing lens.

JP1999-96582A suggests projecting a light beam from a semiconductor laser of an adjustment apparatus from an optical axis direction with respect to an objective lens of an optical head, receiving light reflected by a surface of the objective lens on an optical axis by a 4-element segmented optical sensor, detecting and calculating displacement of reflective light with respect to the optical axis from a light reception quantity of each light reception element, receiving radiation light reflected by the surface of the objective lens by a pair of 2-element segmented optical sensor, detecting and calculating a divergence state from a light reception quantity of each light reception element, detecting an inclination of an optical axis of the objective lens from a calculation result of the 4-element segmented optical sensor, detecting a position of the objective lens on the optical axis from a calculation result of the 2-element segmented optical sensor, and adjusting the position of the objective lens on the optical axis at the same time as adjusting the inclination of the optical axis of the objective lens to 0 based on detection results.

### SUMMARY

Aspects of non-limiting embodiments of the present disclosure relate to an irradiation device and a distance measurement apparatus that can achieve size reduction of an apparatus without inclining a refraction portion, compared to a case of monitoring light of a light source by arranging a transmissive and reflective member on an optical path of light of irradiation from the light source.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an irradiation device including a light source that performs irradiation with light, a refraction portion that has a curved region and is arranged at a position at which the curved region is directly irradiated with the light from the light source, and refracts the light of the irradiation from the light source, and a light reception portion that is arranged at a position, which is adjacent to the light source and at which reflective light reflected by the curved region after the irradiation from the light source is received, and that receives the reflective light.

### BRIEF DESCRIPTION OF THE DRAWINGS

Exemplary embodiment(s) of the present invention will be described in detail based on the following figures, wherein:

FIG. 1 is a diagram illustrating a schematic configuration of a distance measurement apparatus according to the present exemplary embodiment;

FIG. 2 is a block diagram illustrating a hardware configuration of a control portion in the distance measurement apparatus according to the present exemplary embodiment;

FIG. 3 is a perspective view illustrating a schematic configuration of an irradiation device according to a first exemplary embodiment;

FIG. 4 is a side view illustrating a positional relationship among an optical axis of a refraction portion, a light source, and a light reception portion;

FIG. 5 is a top view illustrating the positional relationship among the optical axis of the refraction portion, the light source, and the light reception portion;

FIG. 6 is a diagram illustrating an arrangement example of the light source, the light reception portion, and a circuit substrate;

FIG. 7 is a diagram illustrating a positional relationship between the refraction portion and a WB;

FIG. 8 is a diagram illustrating a configuration of an irradiation device of a first comparative example;

FIG. 9 is a diagram illustrating a configuration of an irradiation device of a second comparative example;

FIG. 10 is a diagram illustrating a configuration of an irradiation device of a third comparative example;

FIG. 11 is a diagram illustrating a configuration of a fourth comparative example;

FIG. 12 is a diagram illustrating a configuration of an irradiation device of a fifth comparative example;

FIG. 13 is a diagram illustrating a light intensity distribution of the light source in a case where a diffractive element is used as a diffusion portion;

FIG. 14 is a diagram illustrating a ray in a case where the refraction portion is configured with two lenses in the irradiation device according to the first exemplary embodiment;

FIG. 15 is a perspective view illustrating a schematic configuration of an irradiation device according to a second exemplary embodiment;

FIG. 16 is a perspective view illustrating a schematic configuration of an irradiation device according to a third exemplary embodiment;

FIG. 17 is a top view of a refraction portion of the irradiation device according to the third exemplary embodiment from an optical axis direction;

FIG. 18 is a top view illustrating an example of an irradiation device to which a light source of a square shape is applied;

FIG. 19 is a top view illustrating an example of an irradiation device including two light reception portions with a plurality of light sources of an oblong shape in 4×4 two-dimensional arrangement;

FIG. 20 is a top view illustrating an example of an irradiation device including two light reception portions with a plurality of light sources of a square shape in 4×2 two-dimensional arrangement;

FIG. 21 is a diagram illustrating an example of a light source including a plurality of light emission elements;

FIG. 22 is a diagram illustrating an example of an irradiation device on which a light reception portion is arranged on a short side and a circuit substrate on a long side; and

FIG. 23 is a diagram illustrating an example of an irradiation device in which a width of an incidence surface is narrower than a width of an emission surface.

### DETAILED DESCRIPTION

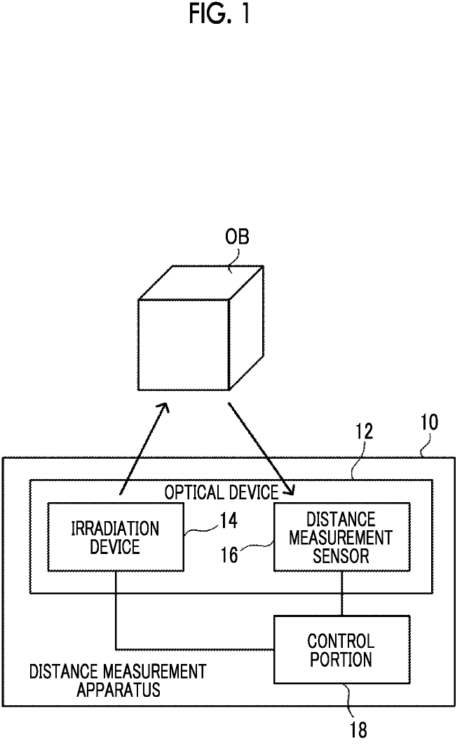

Hereinafter, one example of an exemplary embodiment of the present disclosure will be described in detail with reference to the drawings. FIG. 1 is a diagram illustrating a schematic configuration of a distance measurement apparatus according to the present exemplary embodiment.

A distance measurement apparatus 10 according to the present exemplary embodiment includes an optical device 12 and a control portion 18 as an example of a derivation portion. The control portion 18 controls the optical device 12.

The optical device 12 includes an irradiation device 14 and a distance measurement sensor 16 as an example of a detection portion. The irradiation device 14 irradiates a measured object OB with light from the irradiation device 14, and the distance measurement sensor 16 receives reflective light reflected by the measured object OB. The control portion 18 derives a distance from the distance measurement apparatus 10 to the measured object OB using a light reception result of the distance measurement sensor 16.

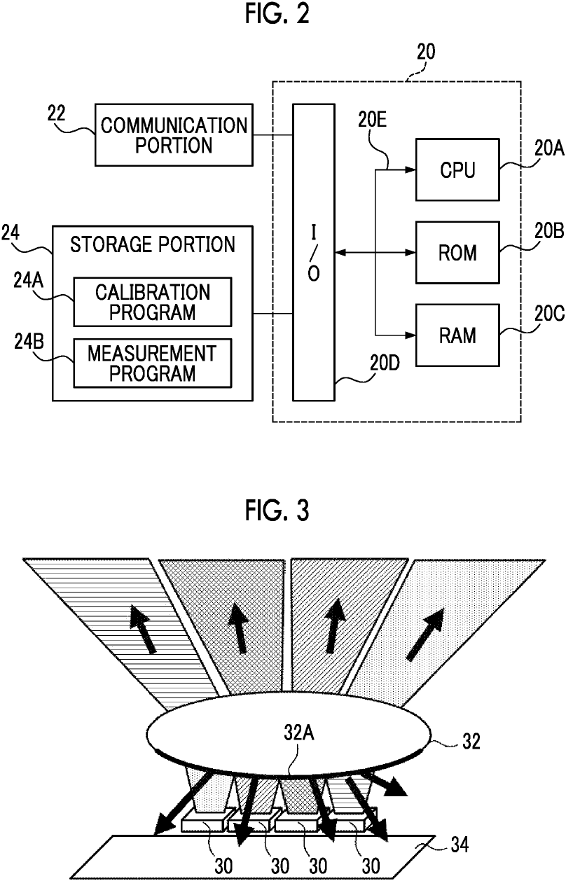

FIG. 2 is a block diagram illustrating a hardware configuration of the control portion 18 in the distance measurement apparatus 10 according to the present exemplary embodiment. As illustrated in FIG. 2, the control portion 18 includes a controller 20. The controller 20 includes a central processing unit (CPU) 20A, a read only memory (ROM) 20B, a random access memory (RAM) 20C, and an input-output interface (I/O) 20D. The CPU 20A, the ROM 20B, the RAM 20C, and the I/O 20D are connected to each other via a systembus 20E. The system bus 20E includes a control bus, an address bus, and a data bus.

In addition, a communication portion 22 and a storage portion 24 are connected to the I/O 20D.

The communication portion 22 is an interface for performing data communication with an external apparatus.

The storage portion 24 is configured with a non-volatile rewritable memory or the like such as a flash ROM and stores programs such as a calibration program 24A and a measurement program 24B, various data, and the like. Calibration of the optical device 12 is performed by causing the CPU 20A to read the calibration program 24A stored in the storage portion 24 into the RAM 20C and execute the calibration program 24A. In addition, the distance from the distance measurement apparatus 10 to the measured object OB is derived by reading the measurement program 24B stored in the storage portion 24 into the RAM 20C and executing the measurement program 24B.

### First Exemplary Embodiment

Next, a configuration of the irradiation device 14 according to the present exemplary embodiment will be described. FIG. 3 is a perspective view illustrating a schematic configuration of the irradiation device 14 according to the present exemplary embodiment.

The irradiation device 14 includes a plurality of light sources 30 that can be driven independently of each other. As illustrated in FIG. 3, the plurality of light sources 30 are arranged along one direction, and irradiation is performed with light from each light source 30. As an example of each light source 30, a vertical cavity surface emitting laser (VCSEL) is applied as an example of a surface emitting light source. While the light source 30 is described as the vertical cavity surface emitting laser (VCSEL) below, the light source 30 is not limited thereto and may be other light sources.

A refraction portion 32 is provided on a light emission side of the light source 30. The measured object OB is irradiated with the light emitted from the light source 30 via the refraction portion 32. For example, the refraction portion 32 is configured with one or more lenses and emits the light in a diffused manner as illustrated in FIG. 3.

The refraction portion 32 has a curved region 32A and is arranged at a position at which the curved region 32A is directly irradiated with the light from the light source 30. The refraction portion 32 refracts the light of the irradiation from the light source 30. In addition, the curved region 32A of the refraction portion 32 is one continuous surface, and the plurality of light sources 30 are arranged such that different positions of the curved region 32A are irradiated with light. The position at which the direct irradiation is performed is a position at which the light from the light source 30 is directly incident on the curved region 32A without passing through anything by not arranging an optical component or the like between the light source 30 and the curved region 32A of the refraction portion 32. The different positions do not mean that the positions are completely different even in a case where light is not perfectly collimated light.

In addition, the irradiation device 14 includes a light reception portion 34 that is arranged at a position, which is adjacent to the light source 30 and at which reflective light reflected by the curved region 32A after the irradiation from the light source 30 is received, and that receives the reflective light from the curved region 32A. Measuring a light emission intensity of the light source 30 by receiving the light of the light source 30 by the light reception portion and providing feedback about a driving condition of the light source 30 cause the light source 30 to emit light with a stable light emission intensity.

The light source 30 is arranged closer to the refraction portion 32 than to a focal position of the refraction portion 32. Accordingly, a short optical path and a large spectral quantity are achieved, compared to a case of arranging the light source 30 further than the focal position of the refraction portion 32. Thus, the reflective light from the curved region 32A is likely to be detected.

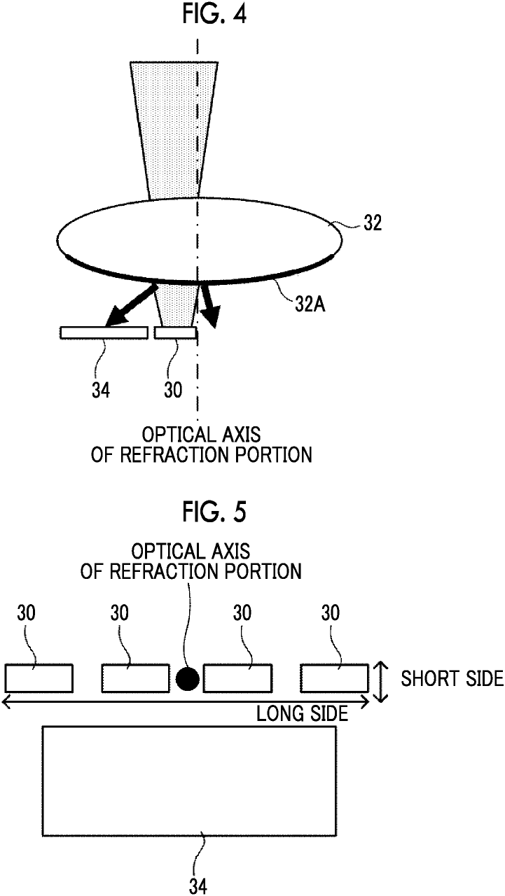

In addition, as illustrated in FIGS. 4 and 5, the light source 30 and the refraction portion 32 are arranged such that an optical axis of the refraction portion 32 deviates from an optical axis of the light source 30. That is, arranging the light source 30 on other than the optical axis of the refraction portion 32 causes light to be reflected by the curved region 32A on a surface of the refraction portion 32. Thus, the reflective light reflected by the curved region 32A is likely to be incident on the light reception portion 34 that is installed at a position adjacent to the light source 30. In a case where the light source 30 is arranged on the optical axis of the refraction portion 32, light is reflected in an approximately flat part near the optical axis on the surface of the refraction portion 32, and the reflective light returns to the light source 30. Thus, the reflective light is unlikely to be incident on the light reception portion 34.

As a reference value, a surface reflectance of the refraction portion 32 is approximately 5% for a surface of glass or a transparent resin and is approximately 1% in a case where an antireflective coating is added.

Not all light sources 30 may deviate from the optical axis of the refraction portion 32, and a part of the light sources 30 may coincide with the optical axis of the refraction portion 32. In this case, light of a part in which the light source 30 coincides with the optical axis of the refraction portion 32 cannot be received by the light reception portion 34. However, the coinciding light sources 30 are smaller than the non-coinciding light sources 30 in number and thus, have a sufficiently small influence.

In addition, as illustrated in FIG. 5, for example, the light reception portion 34 is desirably arranged on a long side that is in an arrangement direction of the plurality of light sources 30, so that a distance from the light source 30 is decreased and a light reception quantity is increased.

In the present exemplary embodiment, approximately 0.2 to 0.4 mm is applied as an example of the distance between the light source 30 and the refraction portion 32, and approximately 3 to 6 mm is applied as an example of a thickness of the refraction portion 32. Approximately 0.2 to 10 m is applied as an example of a distance from the refraction portion 32 to the measured object OB.

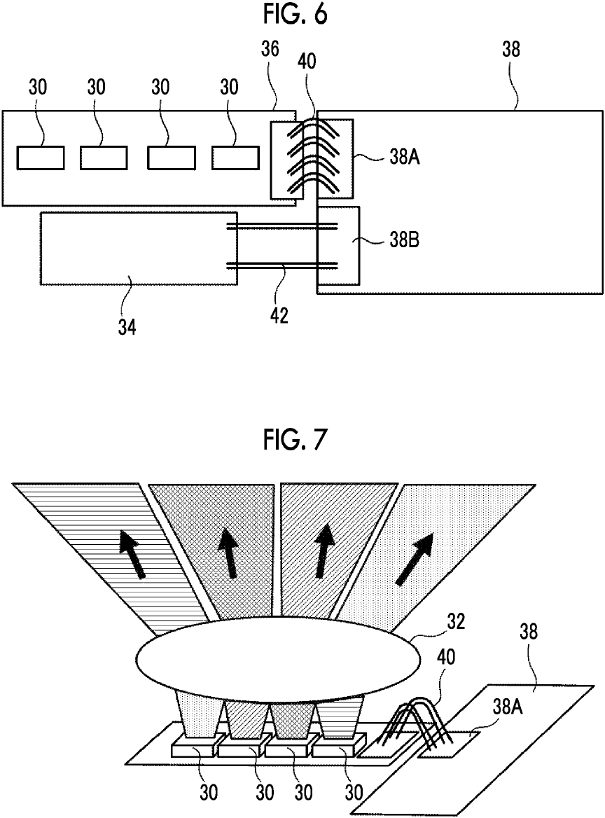

In addition, as illustrated in FIG. 6, a circuit substrate 38 that performs driving of the light source 30, amplification of an output of the light reception portion 34, and the like is provided on a short side that is in a direction orthogonal to the arrangement direction of the plurality of light sources. A wire bonding (WB) pad region 38A in which a WB 40 is connected is provided in the circuit substrate 38, and a light source substrate 36 in which the plurality of light sources 30 are provided is connected to the circuit substrate 38 by the WB 40. As illustrated in FIG. 7, the WB 40 that connects the circuit substrate 38 to the light source substrate 36 is arranged to be not in contact with the refraction portion 32. In addition, a wiring connector region 38B is provided in the circuit substrate 38 and is connected to the light reception portion 34 by a wiring 42. The circuit substrate 38 is connected to the control portion 18 and performs a process of causing the plurality of light sources 30 to sequentially emit light, amplifying a light reception result of the light reception portion 34, and transferring the amplified light reception result to the control portion 18. Accordingly, in the control portion 18, a light emission condition and the like of the light source 30 are controlled using the light reception result of the light reception portion 34 by executing the calibration program. In FIG. 7, a width of an emission surface is almost the same as a width of an incidence surface. A curvature of the curved emission surface is also similar to a curvature of the incidence surface.

Next, an action of the distance measurement apparatus 10 of the above configuration according to the present exemplary embodiment will be described in comparison with first to fourth comparative examples.

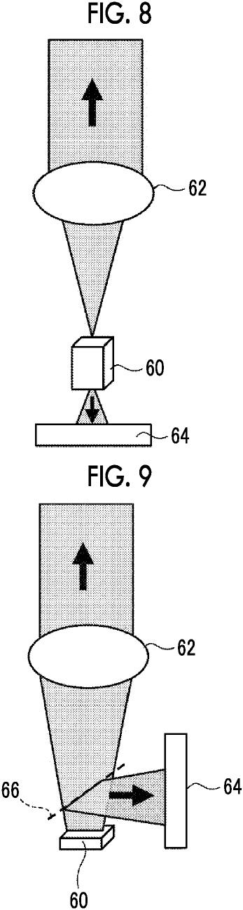

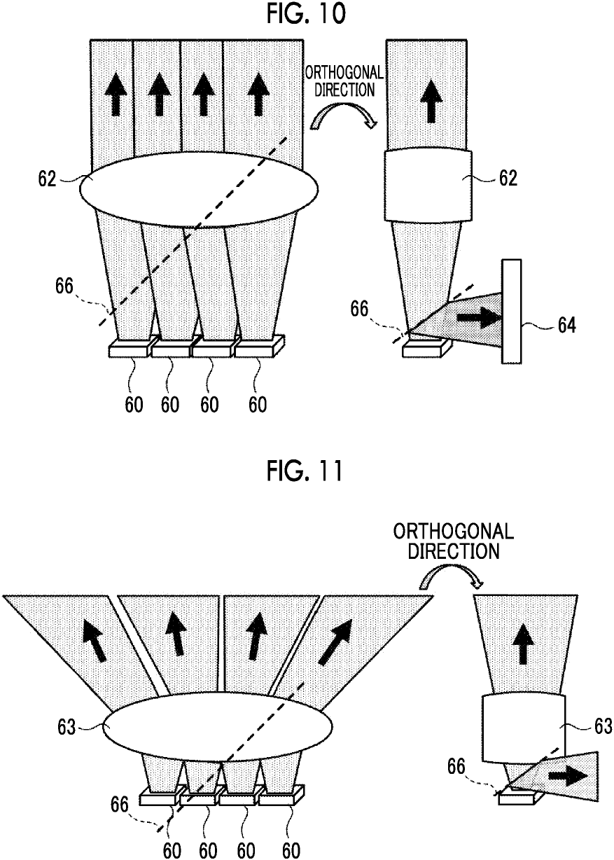

FIG. 8 is a diagram illustrating a configuration of an irradiation device of the first comparative example. FIG. 9 is a diagram illustrating a configuration of an irradiation device of the second comparative example. FIG. 10 is a diagram illustrating a configuration of an irradiation device of the third comparative example. FIG. 11 is a diagram illustrating a configuration of the fourth comparative example.

In the first comparative example, as illustrated in FIG. 8, one edge emitting laser is provided as a light source 60, and irradiation light from the light source 60 is refracted by a refraction portion 62 and output in a narrow angle. In the configuration of the first comparative example, a light emission intensity from an edge on an opposite to an edge used for irradiation is received by a light reception portion 64.

In addition, in the second comparative example, one or more surface emitting lasers are provided as the light source 60, and the irradiation light from the light source 60 is refracted by the refraction portion 62 and output in a narrow angle. The refraction portion 62 has a rotationally symmetric shape about an optical axis as a rotation center, and a light source 60 side of the refraction portion 62 is configured with a convex lens. In the configuration of the second comparative example, an optical component 66 such as a half-silvered mirror is set between the light source 60 and the refraction portion 62, and reflective light from the optical component 66 is received by the light reception portion 64.

In addition, in the third comparative example, one or more surface emitting lasers are provided as a plurality of light sources 60, and the irradiation light from the light source 60 is refracted by the refraction portion 62 and output in a narrow angle. In the third comparative example, as illustrated on a left side in FIG. 10, the entire luminous flux spreads as the number of light sources 60 is increased. Thus, as illustrated on a right side in FIG. 10, the optical component 66 needs to be arranged in an orthogonal direction.

In addition, the fourth comparative example illustrates an example of diffused irradiation to a wide angle (for example, ±45° to 75°) by the plurality of light sources 60 and the refraction portion 63.

The first comparative example cannot be applied to a case of providing the plurality of light sources 60. However, in the second comparative example, even in a case where the plurality of light sources 60 are present, light of each light source 60 is received by the light reception portion 64 as illustrated in the third comparative example.

However, in order to obtain a wide angle like the irradiation device 14 of the present exemplary embodiment, for example, the light source 60 and the refraction portion 62 need to be close to each other by 0.3 mm. In this case, the reflective light overlaps with the optical component 66 even in a structure in which an unnecessary part of the refraction portion 62 is removed, and the optical component 66 cannot be arranged between the light source 60 and the refraction portion 62.

Meanwhile, in the irradiation device 14 of the present exemplary embodiment, the light from the light source 30 is directly incident on the refraction portion 32. The light incident on the refraction portion 32 is reflected by the curved region 32A, and the reflective light is incident on the light reception portion 34. Accordingly, since the light of the light source 30 is received by the light reception portion 34 without arranging the optical component 66, the refraction portion 32 is arranged close to the light source 30, and the measured object OB is irradiated with light diffused by the refraction portion 32.

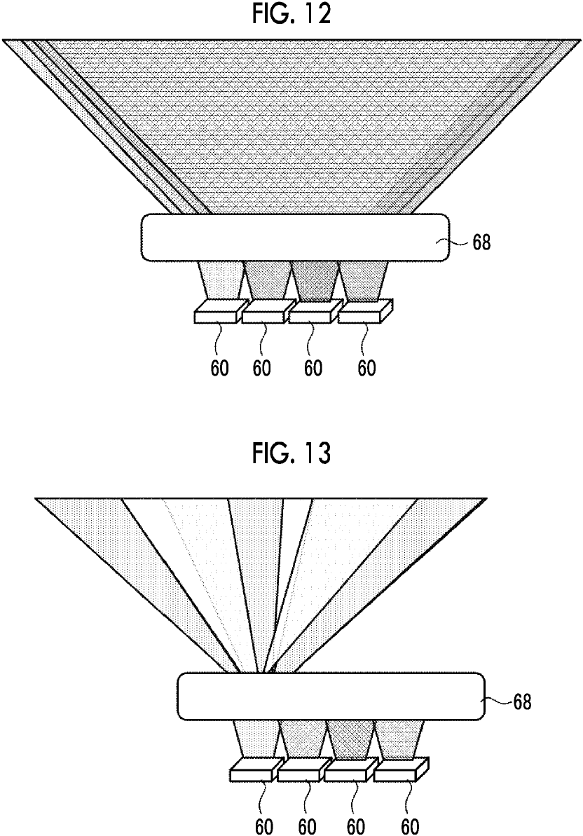

On the other hand, as the irradiation device that performs diffused irradiation, diffusing the light using a diffusion portion 68 such as glass or a microlens (light shaping diffuser (LSD)) or a diffractive element (diffractive optical element (DOE)) as illustrated in FIG. 12 is considered. FIG. 12 is a diagram illustrating a configuration of an irradiation device of a fifth comparative example.

As in the fifth comparative example, in a case of diffusing light using the diffusion portion 68, irradiation ranges of the plurality of light sources 60 overlap with each other as illustrated in FIG. 12. Thus, irradiation cannot be performed by dividing a space.

Meanwhile, in the irradiation device 14 of the present exemplary embodiment, irradiation is performed by dividing a space without causing the irradiation ranges of the plurality of light sources 30 to overlap with each other as illustrated in FIG. 3, by using the refraction portion 32.

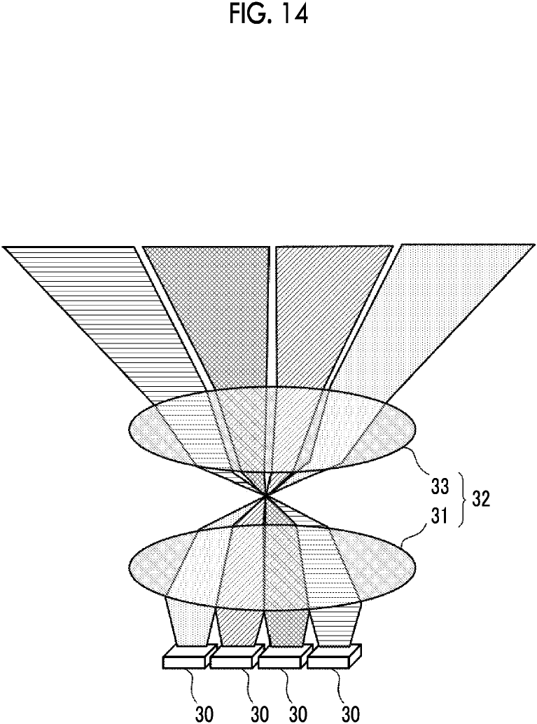

Specifically, in a case of using a diffractive element (DOE) as the diffusion portion 68, divided irradiation is not performed because of overlapping with light intensity distributions of the other light sources 60 (only a light intensity of one light source 60 is illustrated in order to avoid complication) as illustrated in FIG. 13. FIG. 13 is a diagram illustrating a ray of the diffractive element. In FIG. 13, the light intensity distribution of one light source 60 is illustrated, and the light intensity distributions of the other light sources 60 are not illustrated in order to avoid complication.

Meanwhile, in the irradiation device 14 according to the present exemplary embodiment, a ray in a case where the refraction portion 32 is configured with two lenses is as illustrated in FIG. 14. That is, light is designed to be emitted in a vertical direction from the light source 30 while being slightly diffused (for example, approximately 15°), temporarily condensed to the optical axis at the center by a first lens 31, and headed to each desirable direction by a second lens 33. Light of irradiation from the second lens 33 has a wide angle (for example, ±15° to 75°). FIG. 14 is a diagram illustrating a ray in a case where the refraction portion 32 is configured with two lenses in the irradiation device 14 according to the exemplary embodiment.

In the irradiation device 14 of the present exemplary embodiment, the light emission intensity of each light source 30 is monitored by causing the plurality of light sources 30 to sequentially emit light and synchronizing the light emission with the output of the light reception portion 34.

In addition, in the irradiation device 14 of the present exemplary embodiment, by arranging the light reception portion 34 at a position adjacent to a long side of the light source substrate 36 on which the plurality of light sources 30 are arranged, the light source 30 and the light reception portion 34 are likely to be manufactured on an identical plane, and a low cost is achieved.

In addition, in the irradiation device 14 of the present exemplary embodiment, by connecting the circuit substrate 38 to one side on a short side of the light source substrate 36, circuits for the sequential light emission of the light sources 30 and the amplification of the light reception output are easily collectively arranged on one substrate, and effects of simplification and a low cost are achieved. All of the circuits in a state where the circuits are collectively formed as a unit on one substrate may be combined with a unit of the refraction portion.

### Second Exemplary Embodiment

Next, an irradiation device according to a second exemplary embodiment will be described. FIG. 15 is a perspective view illustrating a schematic configuration of the irradiation device according to the second exemplary embodiment. Identical configurations to the above exemplary embodiment will be designated by identical reference numerals and will not be described in detail.

In the present exemplary embodiment, the arrangement of the light reception portion 34 is different from the first exemplary embodiment. That is, as illustrated in FIG. 15, in the present exemplary embodiment, one light reception portion 34 is provided to surround the plurality of light sources 30.

Even in the present exemplary embodiment, as in the first exemplary embodiment, the output on which the light emission intensity is reflected is obtained by causing a part of the luminous flux emitted from the light source 30 to be reflected by the curved region 32A on the surface of the refraction portion 32 and receiving the reflected part of the luminous flux by the light reception portion 34.

Even in the present exemplary embodiment, the light emission intensity of each light source 30 is monitored by causing the plurality of light sources 30 to sequentially emit light and synchronizing the light emission with the output of the light reception portion 34.

### Third Exemplary Embodiment

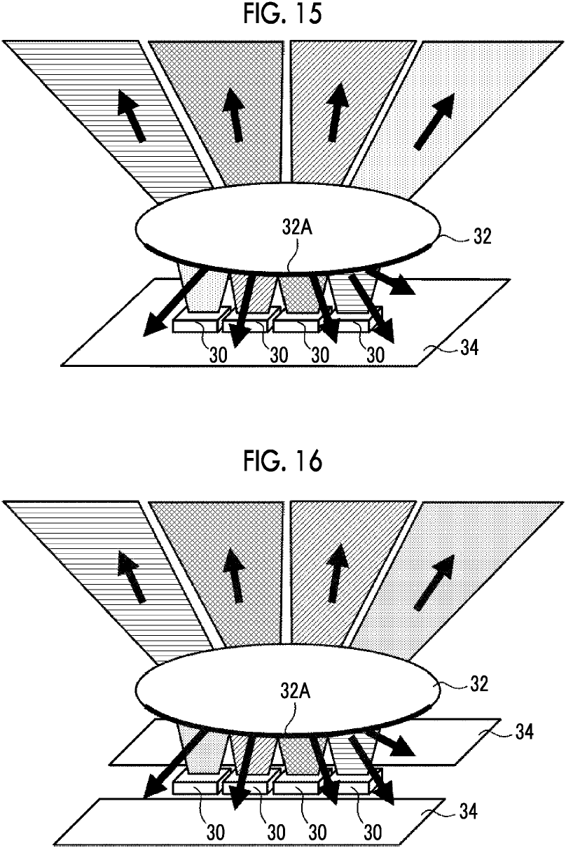

Next, an irradiation device according to a third exemplary embodiment will be described. FIG. 16 is a perspective view illustrating a schematic configuration of the irradiation device according to the third exemplary embodiment. Identical configurations to the above exemplary embodiment will be designated by identical reference numerals and will not be described in detail.

In the present exemplary embodiment, the number of light reception portions 34 is different from each of the above exemplary embodiments, and the light reception portion 34 is arranged at a plurality of positions adjacent to the light source 30. That is, as illustrated in FIG. 16, in the present exemplary embodiment, two light reception portions 34 are provided as an example of the plurality of light reception portions 34. Specifically, as illustrated in FIG. 16, the light reception portion 34 is arranged on both sides of the plurality of light sources 30. In other words, the plurality of light sources 30 are configured to be arranged between the two light reception portions 34. For example, the two light reception portions 34 are preferably arranged in the direction orthogonal to the arrangement direction of the plurality of light sources 30. Accordingly, size reduction is achieved, compared to a case of arrangement along the arrangement direction of the plurality of light sources 30. In the present exemplary embodiment, while an example of arranging the light reception portion 34 on both sides of a long side of a region in which the light source 30 is arranged is illustrated, the present invention is not limited thereto, and a plurality of light reception portions 34 may be provided on one side of the long side of the region in which the light source 30 is arranged. In addition, in the present exemplary embodiment, while an example of providing two light reception portions 34 is illustrated, three or more light reception portions 34 may be provided. For example, the light reception portion 34 may be further arranged on a short side of the region in which the light source 30 is arranged.

As in the above exemplary embodiments, in a case of providing one light reception portion 34, the reflective light from the refraction portion 32 cannot be received as much as possible. Thus, for example, two light reception portions 34 are desirable. In this case, in each light source 30, a ratio of the reflective light to a near side to the reflective light to a far side in FIG. 16 can be calculated. Thus, occurrence of a problem in an output distribution of the surface emitting laser in the light source 30 may be perceived.

FIG. 17 is a top view of the refraction portion 32 of the irradiation device according to the third exemplary embodiment from an optical axis direction and illustrates a positional relationship among the optical axis of the refraction portion 32, the light source 30, and the two light reception portions 34.

As in each of the above exemplary embodiments, in a case where the light source 30 is arranged on the optical axis of the refraction portion 32, the reflective light from the refraction portion 32 heads toward the light source 30 and cannot be received by the light reception portion 34. Thus, the light source 30 is provided at a position except a position on the optical axis of the refraction portion 32.

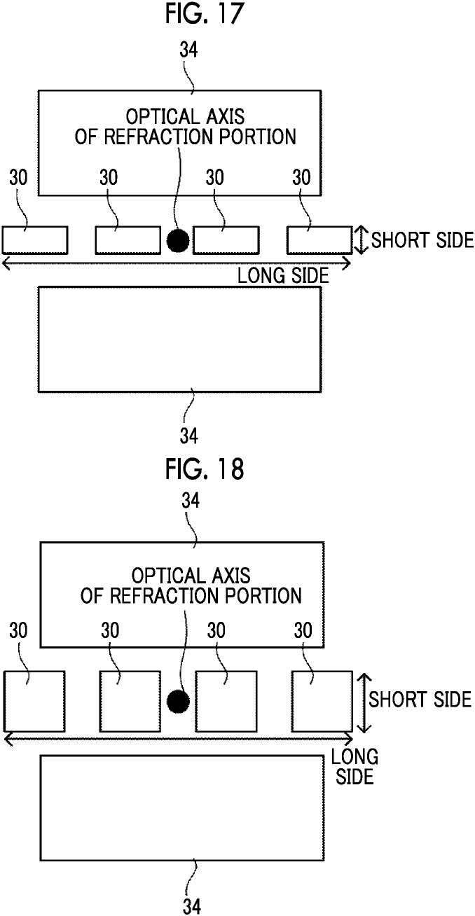

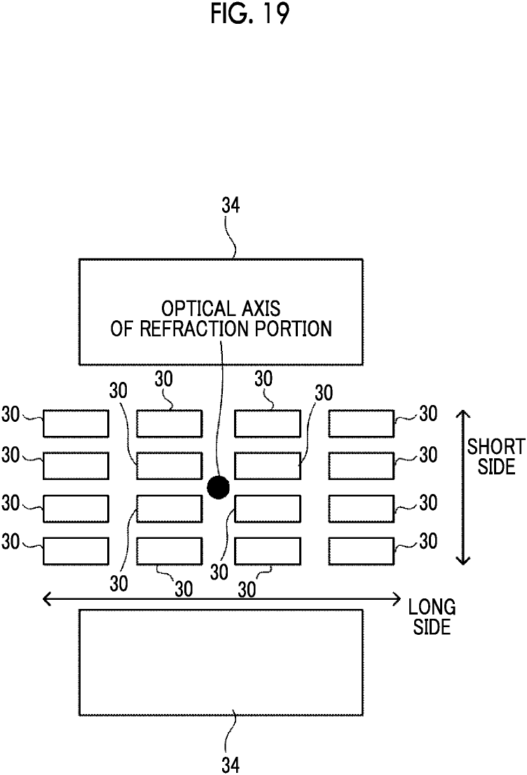

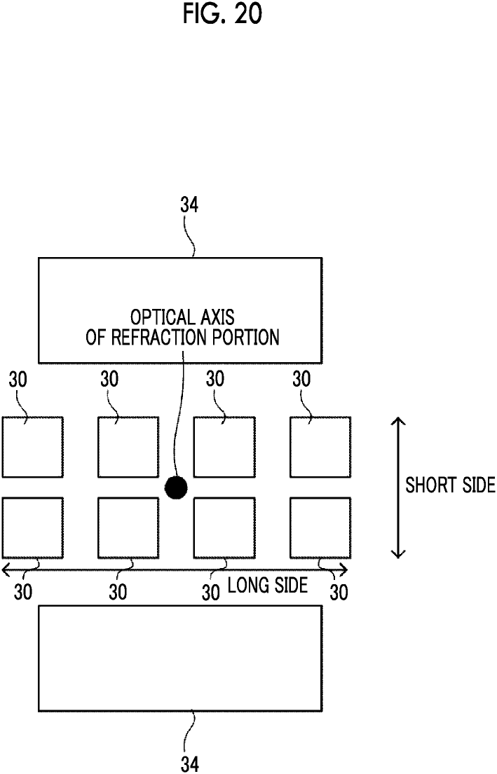

In addition, for example, the light reception portion 34 is desirably provided on the long side of the region in which the plurality of light sources 30 are arranged, so that the distance from the light source 30 is decreased and the light reception quantity is increased. A shape of the light source 30 is not limited to an oblong shape. The light source 30 of a square shape may be applied as illustrated in FIG. 18. Even in a case of applying the light source 30 of a square shape, for example, the light reception portion 34 is preferably arranged on the long side of the region in which the plurality of light sources 30 are arranged.

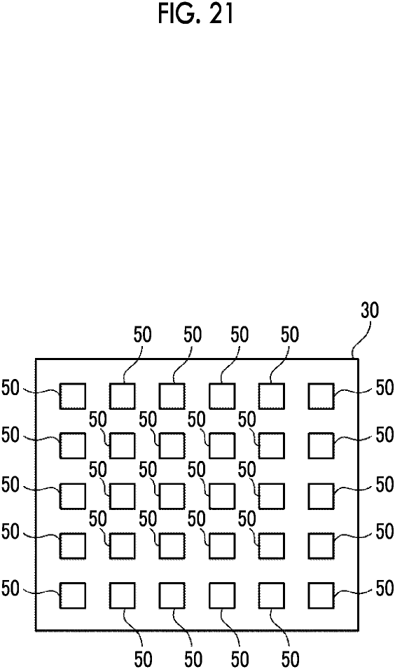

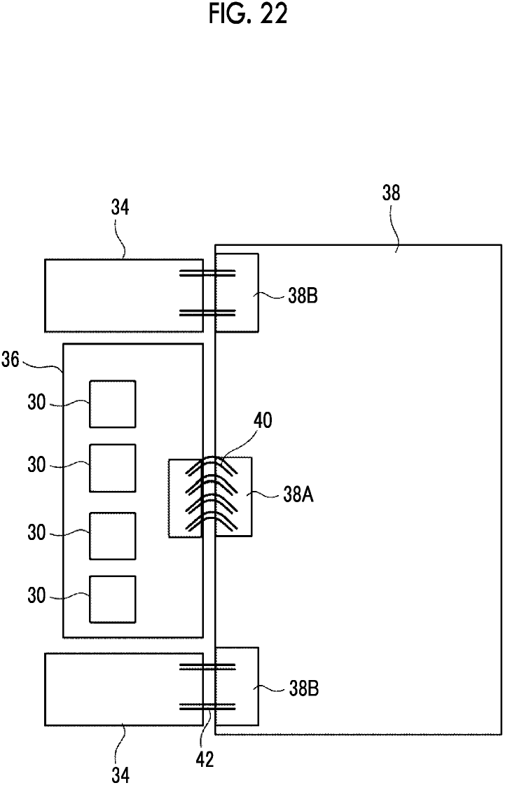

The plurality of light sources 30 may be two-dimensionally arranged as illustrated in FIGS. 19 and 20. FIG. 19 illustrates an example of providing two light reception portions 34 with the plurality of light sources 30 of an oblong shape in 4×4 two-dimensional arrangement. FIG. 20 illustrates an example of providing two light reception portions 34 with the plurality of light sources 30 of a square shape in 4×2 two-dimensional arrangement. In the example of each of FIGS. 19 and 20, the reflective light from the light sources 30 of an upper half in FIGS. 19 and 20 is received by the light reception portion 34 on an upper side in FIGS. 19 and 20, and the reflective light from the light sources 30 on a lower side in FIGS. 19 and 20 is received by the light reception portion 34 on a lower side in FIGS. 19 and 20. Thus, the reflective light is easily distinguished. In addition, while FIGS. 19 and 20 illustrate an example of providing two light reception portions 34, the plurality of light sources 30 may be two-dimensionally arranged in a case of providing one light reception portion 34 as in the above exemplary embodiments. In addition, in a case of providing the plurality of light sources 30 and the plurality of light reception portions 34, the light source 30 and the light reception portion 34 may be alternately arranged.

In addition, in each of the above exemplary embodiments, each of the plurality of light sources 30 may be configured to include a plurality of light emission elements 50 (for example, individual surface emitting lasers) as illustrated in FIG. 21. The light source 30 including the plurality of light emission elements 50 is effective for increasing the light emission intensity of the entire light source 30.

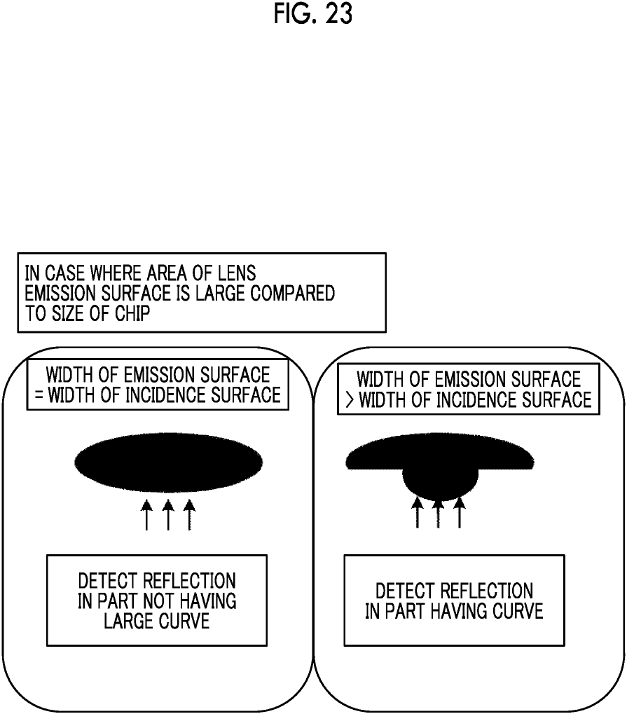

In addition, in each of the above exemplary embodiments, while an example of arranging the light reception portion 34 on the long side of the region in which the light source 30 is arranged and arranging the circuit substrate 38 on the short side is described, the present invention is not limited thereto. For example, as illustrated in FIG. 22, the light reception portion 34 may be arranged on the short side, and the circuit substrate 38 may be arranged on the long side. Compared to each of the above exemplary embodiments, the distance between the light source 30 and the light reception portion 34 is likely to be increased, and the light reception quantity of the light reception portion 34 is likely to be decreased. Thus, for example, each of the above exemplary embodiments is desirable in a case of prioritizing the light reception quantity.

In addition, in each of the above exemplary embodiments, while an example of providing the plurality of light sources 30 is described, one light source may be provided instead of the plurality of light sources.

In addition, in each of the above exemplary embodiments, while an example in which the width of the emission surface is the same as the width of the incidence surface is illustrated, the present invention is not limited thereto. The width of the emission surface may be different from the width of the incidence surface, particularly, a width of the curved region. In a case of irradiating a wider region, an area of the emission surface may be generally increased while this may be different depending on a refraction state. In a case where the width of the incidence surface based on incidence of light is also set to the same width, a curvature of a curve is likely to be gentle. In addition, in a case where a curvature of a curve of the incidence surface is set to be smaller than a curvature of a curve of the emission surface, a length of the refraction portion in the optical axis direction is increased. Thus, in the example illustrated in FIG. 23, the width of the incidence surface is set to be smaller than the width of the emission surface, and the incidence surface is also set to have a smaller radius of curvature. In the configuration in FIG. 23, light enters a part having a smaller radius of curvature of a curve.

In addition, the present disclosure is not limited to the above, and each of the above exemplary embodiments may be appropriately combined. Besides, various modifications can be made without departing from the gist of the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An irradiation device comprising:
a light source that performs irradiation with light;
a refraction portion that has a curved region and is arranged at a position at which the curved region is directly irradiated with the light from the light source, and refracts the light of the irradiation from the light source; and
a light reception portion that is arranged at a position, which is adjacent to the light source and at which reflective light reflected by the curved region after the irradiation from the light source is received, and that receives the reflective light.

2. The irradiation device according to claim 1,
wherein the refraction portion is arranged such that an optical axis of the refraction portion deviates from an optical axis of the light source.

3. The irradiation device according to claim 1,
wherein a plurality of light sources are provided, and each of the plurality of light sources is an independently drivable surface emitting light source.

4. The irradiation device according to claim 2,
wherein a plurality of light sources are provided, and each of the plurality of light sources is an independently drivable surface emitting light source.

5. The irradiation device according to claim 3,
wherein the light reception portion causes the plurality of light sources to sequentially emit light and receives the reflective light.

6. The irradiation device according to claim 4,
wherein the light reception portion causes the plurality of light sources to sequentially emit light and receives the reflective light.

7. The irradiation device according to claim 3,
wherein the curved region is one continuous surface, and each of the plurality of light sources irradiates a different position of the curved region with light.

8. The irradiation device according to claim 4,
wherein the curved region is one continuous surface, and each of the plurality of light sources irradiates a different position of the curved region with light.

9. The irradiation device according to claim 5,
wherein the curved region is one continuous surface, and each of the plurality of light sources irradiates a different position of the curved region with light.

10. The irradiation device according to claim 6,
wherein the curved region is one continuous surface, and each of the plurality of light sources irradiates a different position of the curved region with light.

11. The irradiation device according to claim 1,
wherein in a case where a region in which the light source is arranged has an oblong shape, the light reception portion is arranged at a position adjacent to a long side of the region.

12. The irradiation device according to claim 2,
wherein in a case where a region in which the light source is arranged has an oblong shape, the light reception portion is arranged at a position adjacent to a long side of the region.

13. The irradiation device according to claim 3,
wherein in a case where a region in which the light source is arranged has an oblong shape, the light reception portion is arranged at a position adjacent to a long side of the region.

14. The irradiation device according to claim 4,
wherein in a case where a region in which the light source is arranged has an oblong shape, the light reception portion is arranged at a position adjacent to a long side of the region.

15. The irradiation device according to claim 11,
wherein a circuit substrate of the light source and the light reception portion is arranged on a short side of the region on which the light reception portion is not arranged.

16. The irradiation device according to claim 1,
wherein the light reception portion is arranged at a plurality of positions adjacent to the light source.

17. The irradiation device according to claim 1,
wherein the light source is arranged closer to the refraction portion than to a focal position of the refraction portion.

18. The irradiation device according to claim 1, further comprising:
a control portion that controls the light source using a light reception result of the light reception portion.

19. The irradiation device according to claim 1,
wherein the refraction portion has a greater width in a direction perpendicular to an optical axis than the light source, and a width of an incidence surface of the refraction portion is narrower than a width of an emission surface.

20. A distance measurement apparatus comprising:
an irradiation device including a light source that performs irradiation with light, a refraction portion that has a curved region and is arranged at a position at which the curved region is directly irradiated with the light from the light source, and refracts the light of the irradiation from the light source, and a light reception portion that is arranged at a position, which is adjacent to the light source and at which reflective light reflected by the curved region after the irradiation from the light source is received, and that receives the reflective light;
a detection portion that irradiates a measured object with the light from the irradiation device and detects reflective light reflected by the measured object; and
a derivation portion that derives a distance to the measured object using a detection result of the detection portion.
